(19) United States
(12) Patent Application Publication
(10) Pub. No.: US 2025/0079106 A1
(43) Pub. Date: Mar. 6, 2025

(54) FUSE SOCKET CAP

(71) Applicant: Littelfuse, Inc., Chicago, IL (US)

(72) Inventors: Roel Retardo, Malvar Batangas (PH); Conrado De Leon, Kay-anlog Calamba Laguna (PH); Ednel Manalo, Lipa City Batangas (PH)

(73) Assignee: Littelfuse, Inc., Chicago, IL (US)

(21) Appl. No.: 18/825,188

(22) Filed: Sep. 5, 2024

Related U.S. Application Data
(60) Provisional application No. 63/536,751, filed on Sep. 6, 2023.

(51) Int. Cl. H01H 85/20; H01H 69/02; H01H 85/17; H01H 85/175; H01H 85/43

(52) U.S. Cl. CPC H01H 85/2045; H01H 69/02; H01H 85/17; H01H 85/175; H01H 85/43

(57) ABSTRACT

A fuse device is provided that can include a rectangular fuse and a round fuse socket cap that can include a rectangular receptacle for receiving the fuse. The fuse socket cap and the fuse can be free of red phosphorous, and the rectangular receptacle can consume a percentage of a surface area or a volume of the fuse socket cap below a predetermined threshold that prevents reduction of a breaking capacity of the round fuse socket cap.

### CROSS-REFERENCE TO RELATED APPLICATIONS

This application claims the benefit of priority to U.S. Provisional Patent Application No. 63/536,751, filed Sep. 6, 2023, entitled “FUSE SOCKET CAP,” which is incorporated herein by reference in its entirety.

### FIELD

The present disclosure generally relates to fuse devices. More particularly, the present disclosure relates to a fuse socket cap.

### BACKGROUND

Some known fuse devices are red P versions, meaning these fuse devices include red phosphorous. Known red P fuses are round having a cylindrical profile. As such, socket caps for receiving such fuses are also round and have a cylindrical profile. For example. FIG. 1A is a perspective view of a fuse device 100 with a round fuse 102 in a round socket cap 104 known in the art and including red phosphorous. In this regard, FIG. 1B is a top view of the round socket cap 104 of FIG. 1A, and FIG. 1C is a cross-sectional schematic view of the fuse device 100 of FIG. 1A. As seen best in FIG. 1A, profiles of the round fuse 102 and the round socket cap 104 are both cylindrical. As such, the profiles of the round fuse 102 and the round socket cap 103 are complimentary and generally identical except for size so that an exterior of the profile of the round fuse 102 abuts an interior of the profile of the round socket cap 104 when fitted therein.

Red P free versions of fuse devices, meaning free of red phosphorous, are also known in the art and advantageous for environmental reasons. However, known fuses that are free of red phosphorous are rectangular. As such, socket caps for receiving such fuses are also rectangular. For example, FIG. 2A is a cutaway perspective view of a fuse device 200 with a rectangular fuse 202 in a rectangular socket cap 204 known in the art and free of red phosphorous. In this regard, FIG. 2B is a cutaway side view of the rectangular fuse 202 in the rectangular socket cap 204 of FIG. 2A, and FIG. 2C is a cross-sectional schematic view of the fuse device 200 of FIG. 2A. As best seen in FIG. 2B, profiles of the rectangular fuse 202 and the rectangular socket cap 204 are both rectangular. As such, the profiles of the rectangular fuse 202 and the rectangular socket cap 203 are complimentary and generally identical except for size so that an exterior of the profile for the rectangular fuse 202 abuts an interior of the profile of the rectangular socket cap 204 when fitted therein.

Previous attempts to manufacture red P free versions of round fuse devices resulted in failure during short circuit testing. In particular, when testing a red P free version of a round fuse device, either a socket cap of the fuse device cracked or a body of a fuse ruptured.

In view of the above, there is a continuing, ongoing need for improved devices.

### BRIEF SUMMARY

This Brief Summary is provided to introduce a selection of concepts in a simplified form that are further described below in the Detailed Description. This Brief Summary is not intended to identify key features or essential features of claimed subject matter or intended as an aid in determining scope of the claimed subject matter.

In some embodiments, a fuse device can include a rectangular fuse and a round fuse socket cap that can include a rectangular receptacle for receiving the rectangular fuse. The fuse socket cap and the fuse can be free of red phosphorous, and the rectangular receptacle can have a size less than a predetermined threshold so as to prevent reduction of a breaking capacity of the round fuse socket cap.

In some embodiments, the size of the rectangular receptacle can consume a percentage of a surface area of the round fuse socket cap below the predetermined threshold.

In some embodiments, the size of the rectangular receptacle can consume a percentage of a volume of the round fuse socket cap below the predetermined threshold.

In some embodiments, walls of the round fuse socket cap have at least a predetermined thickness to achieve the breaking capacity.

In some embodiments, the fuse device can include a vent along an outside perimeter of the rectangular receptacle to release exhaust or air pressure within the rectangular receptacle.

In some embodiments, the rectangular fuse can close an outside area of the rectangular receptacle.

In some embodiments, the fuse device can include a nipple dot or a notch on an exterior surface of the round fuse socket cap for orienting the rectangular fuse relative to the rectangular receptacle.

In some embodiments, a fuse socket cap can include a cylindrical housing with a closed end and an open end and a rectangular receptacle disposed in the open end for receiving a rectangular fuse therein. The cylindrical housing can be free of red phosphorous, and the rectangular receptacle can have a size less than a predetermined threshold so as to prevent reduction of a breaking capacity of the cylindrical housing.

In some embodiments, the rectangular receptacle can consume a percentage of a surface area of the cylindrical housing below the predetermined threshold.

In some embodiments, the rectangular receptacle can consume a percentage of a volume of the cylindrical housing below the predetermined threshold.

In some embodiments, walls of the cylindrical housing can have at least a predetermined thickness to achieve the breaking capacity.

In some embodiments, the fuse socket cap can include a vent along an outside perimeter of the rectangular receptacle to release exhaust or air pressure within the rectangular receptacle.

In some embodiments, the rectangular fuse can close an outside area of the rectangular receptacle.

In some embodiments, the fuse socket cap can include a nipple dot or a notch on an exterior surface of the cylindrical housing for orienting the rectangular fuse relative to the rectangular receptacle.

In some embodiments, a method can include manufacturing a cylindrical housing with a closed end and an open end and forming a rectangular receptacle in the open end when the cylindrical housing is for use with a rectangular fuse. The cylindrical housing can be free of red phosphorous, and the rectangular receptacle can have a size less than a predetermined threshold so as to prevent reduction of a breaking capacity of the cylindrical housing.

In some embodiments, the method can include forming a round receptacle in the open end when the cylindrical housing is for use with a round fuse.

In some embodiments, manufacturing the cylindrical housing can include molding the cylindrical housing.

In some embodiments, the method can include modifying a molding tool or a molding capillary of a single mold to alternate between forming the rectangular receptacle and the round receptacle.

In some embodiments, manufacturing the cylindrical housing can include 3D printing the cylindrical housing.

In some embodiments, the method can include modifying a single 3D printing model to alternate between forming the rectangular receptacle and the round receptacle.

Other technical features may be readily apparent to one skilled in the art from the following figures, descriptions, and claims.

### BRIEF DESCRIPTION OF THE SEVERAL VIEWS OF THE DRAWINGS

FIG. 1A is a perspective view illustrating a fuse device known in the art.

FIG. 1B is a top view illustrating a socket cap known in the art.

FIG. 1C is a cross-sectional schematic view illustrating a fuse device known in the art.

FIG. 2A is a cutaway perspective view illustrating a fuse device known in the art.

FIG. 2B is a cutaway side view illustrating a fuse device known in the art.

FIG. 2C is a cross-sectional schematic view illustrating a fuse device known in the art.

FIG. 3A is an exploded perspective view illustrating a fuse device in accordance with disclosed embodiments.

FIG. 3B is a perspective view illustrating a fuse socket cap in accordance with disclosed embodiments.

FIG. 3C is a perspective view illustrating a fuse device in accordance with disclosed embodiments.

FIG. 3D is a bottom schematic view illustrating a fuse socket cap in accordance with disclosed embodiments.

FIG. 4A is a perspective view illustrating a fuse socket cap in accordance with disclosed embodiments.

FIG. 4B is a bottom view illustrating a fuse device in accordance with disclosed embodiments.

FIG. 4C is a bottom schematic view illustrating a fuse socket cap in accordance with disclosed embodiments.

FIG. 5 is a perspective view illustrating a fuse socket cap in accordance with disclosed embodiments.

FIG. 6 is a flow chart of a method in accordance with disclosed embodiments.

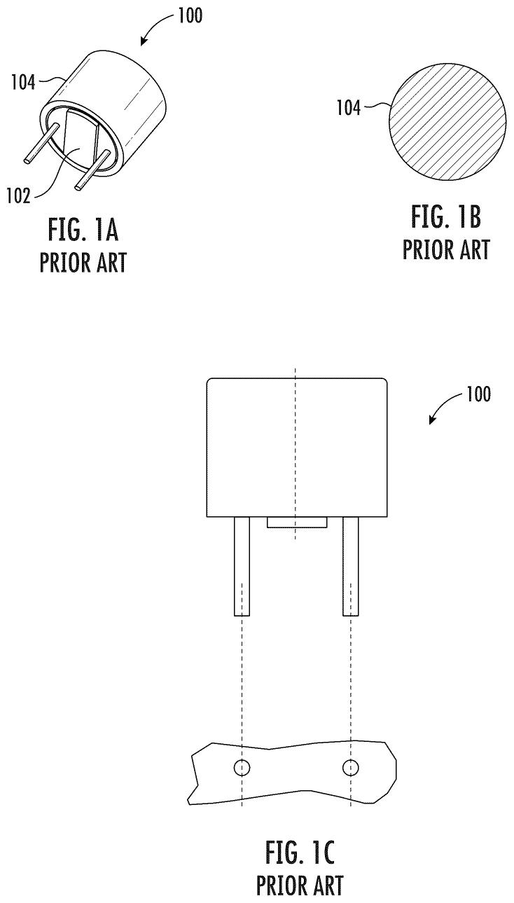

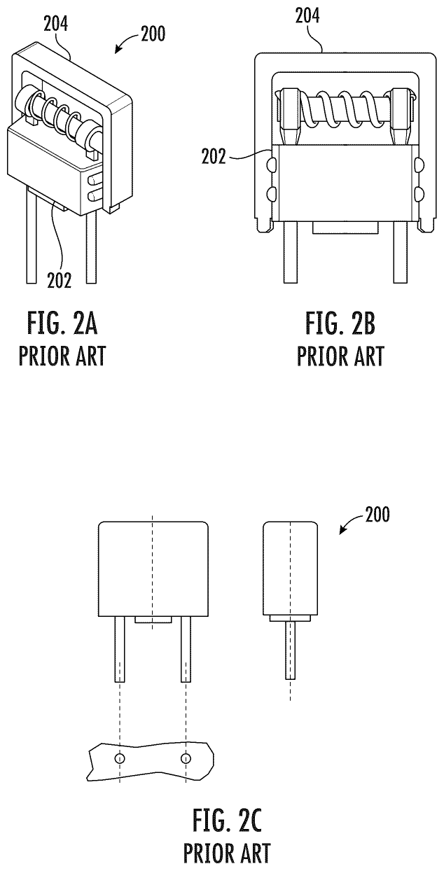

### DETAILED DESCRIPTION

Exemplary embodiments of a fuse socket cap in accordance with the present disclosure will now be described more fully hereinafter with reference made to the accompany drawings. The fuse socket cap may, however, be embodied in many different forms and should not be construed as being limited to the embodiments set forth herein. Rather, these embodiments are provided so that this disclosure will convey certain exemplary aspects of a fuse socket cap to those skilled in the art.

As disclosed herein, the fuse socket cap can be red P free, meaning free of red phosphorous, and can be round having a cylindrical profile. Nevertheless, the fuse socket cap can be used in connection with a fuse that is rectangular having a rectangular profile or a fuse that is round having a cylindrical profile. For example, when the fuse cap socket cap is used in connection with a rectangular fuse, the fuse socket cap can include a rectangular receptacle that can receive and accommodate the rectangular fuse. However, when the fuse cap socket is used in connection with a round fuse, the fuse socket cap can include a round receptacle that can receive and accommodate the round fuse.

Importantly, the fuse socket cap as disclosed herein can be modular in design. As such, the fuse socket cap can be manufactured in the same manner for use in connection with the rectangular fuse and the round fuse with a modification only needed for shaping the receptacle therein. For example, when molded, the fuse socket cap can be molded with one mold in which a molding tool or a molding capillary can be modified to form the receptacle in a rectangular shape or a round shape. Similarly, when 3D printed, the fuse socket cap can be printed with one model in which the receptacle is modified to be either rectangular or round.

Advantageously, when the fuse socket cap is manufactured for use in connection with the rectangular fuse, a wall thickness of the fuse socket cap can be thicker than the wall thickness of devices known in the art so as to improve a breaking capacity of the fuse socket cap relative to devices known in the art. In particular, when rectangular, the receptacle of the fuse socket cap can have a size less than a predetermined threshold so as to prevent reduction of a breaking capacity of the fuse socket cap. For example, in some embodiments, the receptacle can consume a percentage of a surface area of the fuse socket cap that is low enough so that walls of the fuse socket cap surrounding the receptacle have at least a predetermined thickness to achieve at least a predetermined breaking capacity. Additionally or alternatively, in some embodiments, the receptacle can consume a percentage of a volume of the fuse socket cap that is low enough so that walls of the fuse socket cap surrounding the receptacle have at least the predetermined thickness to achieve at least the predetermined breaking capacity.

In some embodiments, the receptacle can include a vent to further improve the breaking capacity of the fuse socket cap. In particular, the receptacle can include one or more vents along an outside perimeter of an outside area of the receptacle to release exhaust and/or air pressure within the receptacle and prevent build up thereof therein. For example, when the fuse is placed within the receptacle, an outside area of the receptacle can be closed and/or covered by the fuse therein except for the one or more vents in the outside perimeter of the outside area of the receptacle, which can remain open.

Known fuses include yarn, sand filler, and/or ceramic paper to absorb heat during a short circuit. However, because the breaking capacity of the fuse socket cap disclosed herein can be improved as described above, bigger yarn can be used in fuses that are used in connection with the fuse socket cap disclosed herein as compared to devices known in the art. Similarly, because the breaking capacity of the fuse socket cap disclosed herein can be improved as described above, the sand filler and/or the ceramic paper can be eliminated or removed in fuses that are used in connection with the fuse socket cap disclosed herein, thereby leading to manufacturing simplicity and cost savings.

In some embodiments, the fuse socket cap can include a nipple dot or a notch on an exterior surface of the fuse socket cap for assistance with orienting the fuse relative to the receptacle of the fuse socket cap during assembly. Indeed, when the receptacle is rectangular, the fuse must be oriented relative thereto to fit properly therein, and the nipple dot or the notch can identify a longitudinal direction of the receptacle for orientation of the fuse without trial and error.

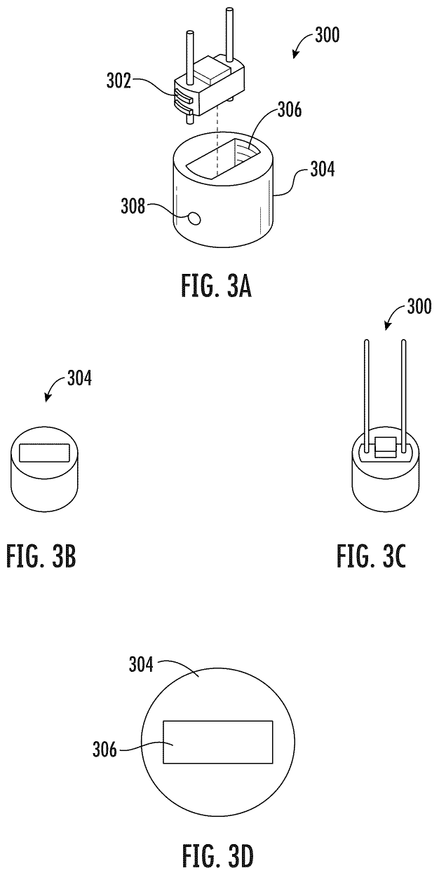

FIG. 3A is an exploded perspective view of a fuse device 300 in accordance with disclosed embodiments. The fuse device can include a fuse socket cap 304 and a fuse 302, both of which can be free of red phosphorous. As seen, the fuse socket cap 304 can be round having a cylindrical profile and include a rectangular receptacle 306 therein for receiving the fuse 302, which is rectangular having a rectangular profile. As also seen, the fuse socket cap 304 can include a nipple dot 308 on an exterior surface of the fuse socket cap 304 for assistance with orienting the fuse 302 relative to the rectangular receptacle 306 of the fuse socket cap 304 during assembly.

FIG. 3B is a perspective view of the fuse socket cap 304 of FIG. 3A. As seen, the fuse socket cap 304 can include a cylindrical housing with a closed end and an open end, and the rectangular receptacle 306 can be disposed in the open end for receiving the fuse 302 therein. As also seen, the rectangular receptacle 306 can have a size less than a predetermined threshold so as to prevent reduction of a breaking capacity of the fuse socket cap 304. For example, in some embodiments, the rectangular receptacle 306 can consume a percentage of a surface area of the fuse socket cap 304 that is low enough so that walls of the fuse socket cap 304 surrounding the receptacle have at least a predetermined thickness to achieve at least a predetermined breaking capacity. Additionally or alternatively, in some embodiments, the rectangular receptacle 306 can consume a percentage of a volume of the fuse socket cap 304 that is low enough so that walls of the fuse socket cap 304 surrounding the receptacle have at least a predetermined thickness to achieve at least a predetermined breaking capacity.

FIG. 3C is a perspective view of the fuse device 300 of FIG. 3A. As seen, when the fuse 302 is placed within the receptacle 306, an outside exterior area of the receptacle 306 can be closed and/or covered by the fuse 302 therein.

FIG. 3D is a bottom schematic view of the fuse socket cap 304 of FIG. 3A. It is to be understood that dimensions of the fuse socket cap 304, the receptacle 306, and the walls of the fuse socket cap 306 illustrated in FIG. 3D are exemplary only and that other dimensions come within the spirit and scope of disclosed embodiments.

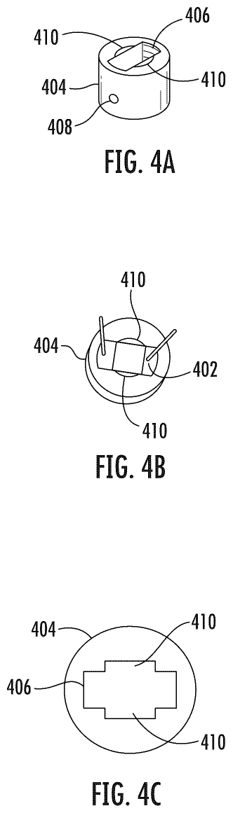

FIG. 4A is a perspective view of a fuse socket cap 404 in accordance with disclosed embodiments. As seen in the embodiment shown in FIG. 4A, the fuse socket cap 404 can be generally identical to the fuse socket cap 304 except that a receptacle 406 of the fuse socket cap 404 can include one or more vents 410 to improve a breaking capacity of the fuse socket cap 404. In particular, the receptacle 406 can include one or more vents 410 along an outside perimeter of an outside exterior area of the receptacle 406 to release exhaust and/or air pressure within the receptacle 406 and prevent build up thereof therein.

FIG. 4B is a bottom view of the fuse socket cap 404 of FIG. 4A with a fuse 402 placed within the receptacle 406. As seen, the outside exterior area of the receptacle 406 can be closed and/or covered by the fuse 402 therein except for the one or more vents 410 in the outside perimeter of the outside exterior area of the receptacle 406, which can remain open.

FIG. 4C is a bottom schematic view of the fuse socket cap 404 of FIG. 4A. It is to be understood that dimensions of the fuse socket cap 404, the receptacle 406, the vents 410, and the walls of the fuse socket cap 404 illustrated in FIG. 4C are exemplary only and that other dimensions come within the spirit and scope of disclosed embodiments.

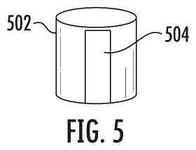

FIG. 5 is a perspective view of a fuse socket cap 502 in accordance with disclosed embodiments. As seen in the embodiment shown in FIG. 5, the fuse socket cap 502 can include a notch 504 on an exterior surface of the fuse socket cap 502 for assistance with orienting a fuse relative to a receptacle of the fuse socket cap 502 during assembly.

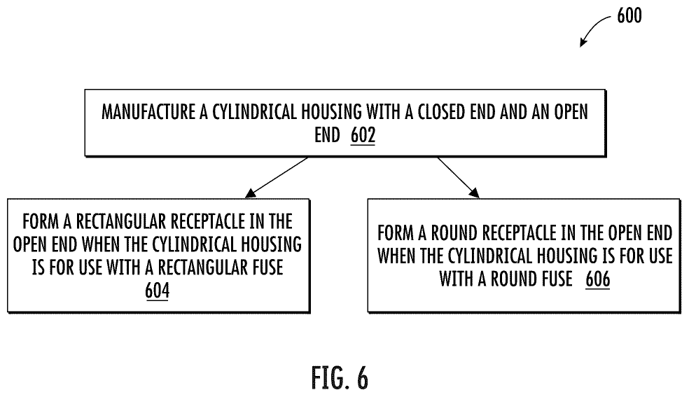

FIG. 6 is a flow chart of a method 600 in accordance with disclosed embodiments. As seen in FIG. 6, the method 600 can include manufacturing a cylindrical housing with a closed end and an open end as in 602 such that the cylindrical housing can be free of red phosphorous. When the cylindrical housing is for use in connection with a rectangular fuse, the method 600 can include forming a rectangular receptacle in the open end as in 604 such that the rectangular receptacle can have a size less than a predetermined threshold so as to prevent reduction of a breaking capacity of the cylindrical ho using.

In some embodiments, manufacturing the cylindrical housing can include molding the cylindrical housing, and in these embodiments, the method 600 can include modifying a molding tool or a capillary of a single mold to alternate between forming the rectangular receptacle and the round receptacle. Additionally or alternatively, in some embodiments, manufacturing the cylindrical housing can include 3D printing the cylindrical housing, and in these embodiments, the method 600 can include modifying a single 3D printing model to alternate between forming the rectangular receptacle and the round receptacle.

As used herein, an element or a step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

While the present disclosure makes reference to certain embodiments, numerous modifications, alterations, and changes to the described embodiments are possible without departing from the sphere and scope of the present disclosure, as defined in the appended claims. Accordingly, it is intended that the present disclosure not be limited to the described embodiments, but that it has the full scope defined by the language of the following claims and equivalents thereof.

What is claimed is:

1. A fuse device comprising:
a rectangular fuse; and
a round fuse socket cap that includes a rectangular receptacle for receiving the fuse,
wherein the fuse socket cap and the fuse are free of red phosphorous, and
wherein the rectangular receptacle consumes a percentage of a surface area or a volume of the fuse socket cap below a predetermined threshold that prevents reduction of a breaking capacity of the round fuse socket cap.

2. The fuse device of claim 1 wherein the size of the rectangular receptacle consumes a percentage of a surface area of the round fuse socket cap below the predetermined threshold.

3. The fuse device of claim 1 wherein the size of the rectangular receptacle consumes a percentage of a volume of the round fuse socket cap below the predetermined threshold.

4. The fuse device of claim 1 wherein walls of the round fuse socket cap have at least a predetermined thickness to achieve the breaking capacity.

5. The fuse device of claim 1 further comprising:
a vent along an outside perimeter of the rectangular receptacle to release exhaust or air pressure within the rectangular receptacle.

6. The fuse device of claim 1 wherein the rectangular fuse closes an outside area of the rectangular receptacle.

7. The fuse device of claim 1 further comprising:
a nipple dot or a notch on an exterior surface of the round fuse socket cap for orienting the rectangular fuse relative to the rectangular receptacle.

8. A fuse socket cap comprising:
a cylindrical housing with a closed end and an open end; and
a rectangular receptacle disposed in the open end for receiving a rectangular fuse therein,
wherein the cylindrical housing is free of red phosphorous, and
wherein the rectangular receptacle has a size less than a predetermined threshold that prevents reduction of a breaking capacity of the cylindrical housing.

9. The fuse socket cap of claim 8 wherein the rectangular receptacle consumes a percentage of a surface area of the cylindrical housing below the predetermined threshold.

10. The fuse socket cap of claim 8 wherein the rectangular receptacle consumes a percentage of a volume of the cylindrical housing below the predetermined threshold.

11. The fuse socket cap of claim 8 wherein walls of the cylindrical housing have at least a predetermined thickness to achieve the breaking capacity.

12. The fuse socket cap of claim 8 further comprising:
a vent along an outside perimeter of the rectangular receptacle to release exhaust or air pressure within the rectangular receptacle.

13. The fuse socket cap of claim 8 wherein the rectangular fuse closes an outside area of the rectangular receptacle.

14. The fuse socket cap of claim 8 further comprising:
a nipple dot or a notch on an exterior surface of the cylindrical housing for orienting the rectangular fuse relative to the rectangular receptacle.

15. A method comprising:
manufacturing a cylindrical housing with a closed end and an open end; and
forming a rectangular receptacle in the open end when the cylindrical housing is for use with a rectangular fuse,
wherein the cylindrical housing is free of red phosphorous, and
wherein the rectangular receptacle has a size less than a predetermined threshold that prevents reduction of a breaking capacity of the cylindrical housing.

16. The method of claim 15 further comprising:
forming a round receptacle in the open end when the cylindrical housing is for use with a round fuse.

17. The method of claim 16 wherein manufacturing the cylindrical housing includes molding the cylindrical housing.

18. The method of claim 17 further comprising:
modifying a molding tool or a molding capillary of a single mold to alternate between forming the rectangular receptacle and the round receptacle.

19. The method of claim 16 wherein manufacturing the cylindrical housing includes 3D printing the cylindrical housing.

20. The method of claim 16 further comprising:
modifying a single 3D printing model to alternate between forming the rectangular receptacle and the round receptacle.
